(19) United States
(12) Patent Application Publication
(10) Pub. No.: US 2015/0130854 A1
(43) Pub. Date: May 14, 2015

(54) LIQUID-CRYSTAL DISPLAY DEVICE AND METHOD FOR DRIVING SAME

(71) Applicant: Sharp Kabushiki Kaisha, Osaka (JP)

(72) Inventors: Shinji Matsumoto, Osaka (JP); Masae Kawabata, Osaka (JP); Kentaroh Irie, Osaka (JP)

(73) Assignee: Sharp Kabushiki Kaisha, Osaka (JP)

(21) Appl. No.: 14/405,001

(22) PCT Filed: May 29, 2013
(86) PCT No.: PCT/JP2013/064855

§ 371 Date: Dec. 2, 2014

(30) Foreign Application Priority Data
Jun. 5, 2012 (JP) 2012-127908

(51) Int. Cl. G09G 3/34; G09G 3/36; H04N 13/04; G02B 27/22; G02F 1/1335

(52) U.S. Cl. CPC G09G 3/3406; G02B 27/2264; G02F 1/133603; H04N 13/0438; H04N 13/0497; G09G 3/3611
USPC 345/690; 345/102

(57) ABSTRACT

An objective of the present invention is to implement a liquid crystal display device which is capable of a three dimensional display, with which it is possible to alleviate image quality degradation caused by crosstalk when a difference in gradation between a left eye image and a right eye image is large. Provided is a liquid-crystal display device that is capable of a three dimensional display, in which a panel drive control circuit alternately performs writing of a right-eye image and writing of a left-eye image for each frame period in order from one end to another end of a liquid crystal panel, and performs writing of either a near-black image or a black image in order from the one end to the other end of the liquid crystal panel in a vertical blanking period during each of the frame periods.

### TECHNICAL FIELD

The present invention relates to a liquid crystal display device, and in particular to a liquid crystal display device that can perform three dimensional display.

### BACKGROUND ART

In recent years, many liquid crystal display devices that can display three dimensional images such as 3D televisions are being sold. In liquid crystal display devices that employ the field sequential method, which is one method of attaining three dimensional display, a left eye image and a right eye image are alternately displayed in a liquid crystal panel per prescribed period ( 1/120 of a second, for example), and lenses of active shutter 3D glasses alternately open and close in synchronization therewith. FIG. 19 is a schematic view showing the progression of image writing (here, writing refers to charging the pixel capacitance in a liquid crystal panel based on the image signal having the target potential) in respective locations of the liquid crystal panel of a conventional liquid crystal display device that can perform three dimensional display. Here, it is assumed that the right eye image is displayed at an even number frame and that the left eye image is displayed at an odd number frame. In FIG. 20, the vertical axis indicates the position on the liquid crystal panel and the horizontal axis indicates time. The arrow with the reference character 81 shows that writing of the right eye image takes place from the upper portion of the panel to the lower portion of the panel in that order during the display period of the odd frame. The arrow with the reference character 82 shows that writing of the right eye image takes place from the upper portion of the panel to the lower portion of the panel in that order during the display period of the odd frame. As for a position P1 of the liquid crystal panel, a right eye image is written at the time t81 for an even frame, and a left eye image is written at the time t82 for an odd frame. As writing takes place alternatively between writing of the right eye image and writing of the left eye image, the left eye and the right eye views an image with a parallax difference leading to the viewer perceiving the image as being three-dimensional.

Reducing crosstalk has been a problem for liquid crystal display devices that can perform three dimensional display. Crosstalk refers to the phenomenon in which a left eye image is also seen by the right eye of the viewer and a right eye image is also seen by the left eye of the viewer, resulting in the left eye image and the right eye image being perceived as overlapping each other. As countermeasures to minimize a decrease in image quality resulting from crosstalk, an increase in drive frequency of liquid crystal panels, improvements in light emission control in LED backlights, and improvements in liquid crystal responsiveness have been conventionally done. Another countermeasure is to display a completely black image (hereinafter, black image) during the time between the display period of the left eye image and the display period of the right eye image.

An invention relating to the present invention is disclosed in Japanese Patent Application Laid-Open Publication No. 2007-286135 regarding a liquid crystal display device that can reduce the frame memory of the panel module by associating the speed of the image signal and the black insertion signal to be inputted to the panel with the image signal process.

### RELATED ART DOCUMENTS

### Patent Documents

Patent Document 1: Japanese Patent Application Laid-Open Publication No. 2007-286135

### SUMMARY OF THE INVENTION

### Problems to be Solved by the Invention

However, when there is a large difference in gradation value between the left eye image and the right eye image, crosstalk occurs due to the response speed of the liquid crystals being insufficient. In a case in which the gradation value is 255 for the right eye image and the gradation value for the left eye image is 0, the change in luminance (gradation level) is as shown in FIG. 20. As can be seen from the portion with the reference character 83 in FIG. 20, even though the gradation value of the left eye image is 0, the gradation level in the actual operation does not reach 0. As a result, during the period when the left eye image should be viewed, an image resulting from the excess gradation is perceived and the crosstalk worsens. The invention of the liquid crystal display device disclosed in Japanese Patent Application Laid-Open Publication No. 2007-286135 aims at reducing the amount of frame memory and cannot suppress the decrease in image quality due to crosstalk.

An object of the present invention is to realize a liquid crystal display device by which it is possible to perform three-dimensional display by which it is possible to suppress the decrease in image quality due to crosstalk when the difference in the gradation level between the right eye image and the left eye image is large.

### Means for Solving the Problems

A first aspect of the present invention is a liquid crystal display device, including:
a liquid crystal panel including a plurality of scan signal lines and a plurality of image signal lines that intersect with the plurality of scan signal lines, the liquid crystal panel displaying a three dimensional image by alternately displaying a left eye image and a right eye image;
a plurality of light sources as a backlight that radiates light to a rear surface of the liquid crystal panel;
a light source control unit that controls an intensity of light emitted by the plurality of light sources; and
a liquid crystal panel driving unit that drives the liquid crystal panel,
wherein the liquid crystal panel driving unit writes to the liquid crystal panel the left eye image and the right eye image in alternating frame periods from one edge to an opposite edge of the liquid crystal panel in a direction extending along the plurality of image signal lines, and writes to the liquid crystal panel a near-black image or a black image from the one edge to the opposite edge of the liquid crystal panel during a vertical blanking period in each frame period.

A second aspect of the present invention is the first aspect of the present invention, wherein the liquid crystal panel driving unit scans the plurality of scan signal lines in an interlacing fashion such that either one of the left eye image and the right eye image is displayed by scanning odd numbered scan signal lines among the plurality of scan signal lines, and another of the left eye image and the right eye image is displayed by scanning even numbered scan signal lines among the plurality of scan signal lines.

A third aspect of the present invention is the first aspect of the present invention, wherein the liquid crystal panel driving unit writes to the liquid crystal panel the near-black image or the black image at a speed faster than a speed by which the left eye image or the right eye image is written to the liquid crystal panel.

A fourth aspect of the present invention is the first aspect of the present invention, wherein the liquid crystal panel driving unit writes the black image to the liquid crystal panel during the vertical blanking period in each frame period.

A fifth aspect of the present invention is the first aspect of the present invention, wherein the liquid crystal panel driving unit writes the near-black image to the liquid crystal panel during the vertical blanking period in each frame period.

A sixth aspect of the present invention is the fifth aspect of the present invention, wherein the near-black image is an image having a gradation of one tenth of a maximum gradation value.

A seventh aspect of the present invention is a method of driving a liquid crystal display device including: a liquid crystal panel including a plurality of scan signal lines and a plurality of image signal lines that intersect with the plurality of scan signal lines; and a plurality of light sources as a backlight that radiates light to a rear surface of the liquid crystal panel, the liquid crystal panel displaying a three dimensional image by alternately displaying a left eye image and a right eye image, the method including:
controlling an intensity of light emitted by the plurality of light sources; and
driving the liquid crystal panel,
wherein, in the step of driving the liquid crystal panel, the left eye image and the right eye image are written to the liquid crystal panel in alternating frame periods from one edge to an opposite edge of the liquid crystal panel in a direction extending along the plurality of image signal lines, and a near-black image or a black image is written to the liquid crystal panel during a vertical blanking period of each frame period from the one edge to the opposite edge of the liquid crystal panel.

### Effects of the Invention

According to the first aspect of the invention, in a liquid crystal display device that can perform three dimensional display by the frame sequential method, a black image is written during the vertical blanking period of each frame period. As a result, in a case in which the difference in gradation level is large between the left eye image and the right eye image, writing of a low gradation image in the liquid crystal panel occurs twice in one frame period. As a result, when the writing of an image takes place for an image with low gradation, the gradation level reached can be sufficiently lowered. Thus, unlike before, an image having excess gradation is not perceived. Thus, a liquid crystal display device that can perform three-dimensional display by which it is possible to suppress the decrease in image quality due to crosstalk when the difference in the gradation level between the right eye image and the left eye image is large is realized.

According to the second aspect of the present invention, the black image is kept in the line for displaying the left eye image during the period when writing of the right eye image occurs, and the black image is kept in the line for displaying the right eye image during the period when writing of the left eye image occurs. Thus, the period during which the black image is held at each pixel is long, and thus, the gradation level is reliably and sufficiently low during the period in which the black image is held. As a result, when the difference in gradation level is high between the left eye image and the right eye image, the decrease in image quality caused by crosstalk can be efficiently suppressed. As the gradation level becomes reliably and sufficiently low during the period during which the black image is held, a gradation change from the intermediate gradation does not occur when writing of the right eye image or the left eye image is performed. Therefore, when writing of the right eye image or the left eye image is performed, the liquid crystals respond promptly. Thus, the usage of overshoot driving becomes unnecessary. As a result, it is possible to reduce the size of the circuit and decrease the memory capacitance.

According to the third aspect of the present invention, writing of the black image is performed in a shorter time than the actual images (left eye image and right eye image).

According to the fourth aspect of the present invention, writing of the black image is performed before the writing of the left eye image and the right eye image is performed, and thus, the phenomenon in which an image with excess gradation is perceived when an image with low gradation is written after an image with high gradation can be effectively suppressed.

According to the fifth aspect of the present invention, effects similar to the first invention can be obtained while also reducing the luminance of the image with a high gradation.

According to the fifth aspect of the present invention, effects similar to the first invention can be obtained while also reducing the luminance of the image with a high gradation.

According to the seventh aspect of the present invention, effects similar to the first aspect of the present invention can be achieved by an invention obtained by a method of driving a liquid crystal display device.

### BRIEF DESCRIPTION OF THE DRAWINGS

FIG. 1 is a schematic view showing the progression of image writing at respective positions on a liquid crystal panel of the liquid crystal display device according to Embodiment 1 of the present invention.

FIG. 2 is a block diagram showing the overall configuration of the liquid crystal display device in Embodiment 1.

FIG. 3 is a plan view showing the configuration of a backlight of Embodiment 1.

FIG. 4 is a plan view showing the configuration of a backlight according to another example of Embodiment 1.

FIG. 5 is a block diagram showing the configuration of the display control circuit in Embodiment 1.

FIG. 6 is a drawing showing the configuration of one frame period according to Embodiment 1.

FIG. 7 is a drawing showing the configuration of another example of one frame period according to Embodiment 1.

FIG. 8 is a view for explaining the effects of the driving method in Embodiment 1.

FIG. 9 is a schematic view showing the progression of image writing in respective positions on the liquid crystal panel according to Embodiment 1 of the present invention.

FIG. 10 is a view showing the change in luminance (gradation level) when the difference in gradation value is large between the left eye image and the right eye image in Embodiment 1.

FIG. 11 is a view showing the configuration of one frame period in a modification example of Embodiment 1.

FIG. 12 is a flow chart showing the process of image writing for one screen in the liquid crystal display device according to Embodiment 2 of the present invention.

FIG. 13 is a schematic view showing the progression of image writing in respective positions on the liquid crystal panel of the liquid crystal display device according to Embodiment 2 of the present invention.

FIG. 14 is a schematic view showing the progression of image writing in respective positions on the liquid crystal panel of the liquid crystal display device according to Embodiment 2 of the present invention.

FIG. 15 is a view showing an example of an overshoot LUT.

FIG. 16 is a block diagram showing the configuration of the display control circuit when overshoot driving is performed.

FIG. 17 is a view for explaining the effects of Embodiment 2.

FIG. 18 is a view for explaining the effects of Embodiment 2.

FIG. 19 is a schematic view showing the progression of image writing in respective positions on the liquid crystal panel of a conventional liquid crystal display device.

FIG. 20 is a view showing the change in luminance (gradation level) when the difference in gradation value is large between the left eye image and the right eye image of a conventional device.

### DETAILED DESCRIPTION OF EMBODIMENTS

Below, embodiments of the present invention will be explained with reference to the appended figures.

### 1. Embodiment 1

### 1.1 Overall Configuration and Summary of Operation

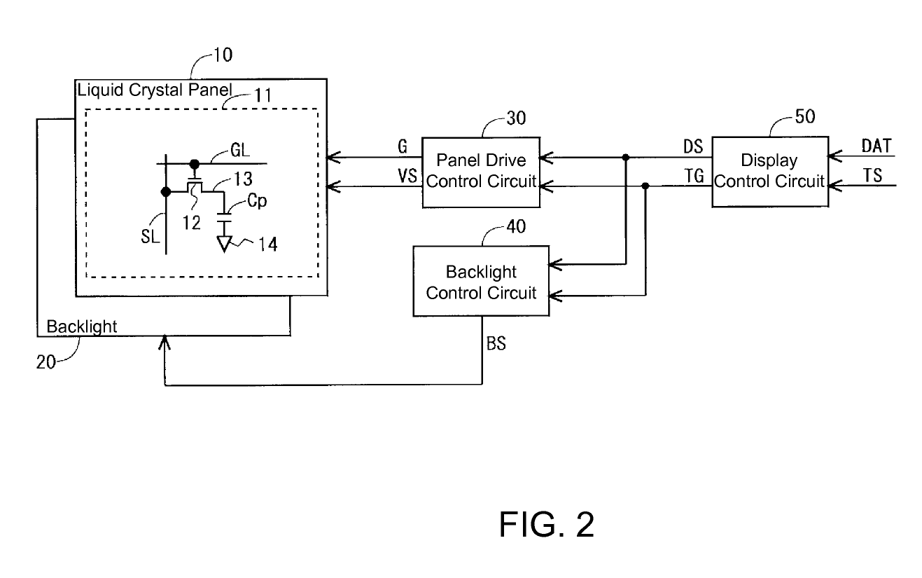

FIG. 2 is a block diagram showing a configuration of a liquid crystal display device according to Embodiment 1 of the present invention. This liquid crystal display device has a liquid crystal panel 10, a backlight 20, a panel drive control circuit (liquid crystal panel driving unit) 30, a backlight control circuit (light source control unit) 40, and a display control circuit 50. The liquid crystal display device is configured such that three dimensional display (stereoscopic vision) can be performed. As a method of attaining three dimensional display, the frame sequential method by which a left eye image and a right eye image are alternately displayed is adopted. Typically, so called double speed driving and quadruple speed driving is adopted.

The liquid crystal panel 10 includes a display unit 11. The display unit 11 is provided with a plurality of image signal lines SL and a plurality of scan signal lines GL. At each intersection of image signal lines SL and scan signal lines GL, a pixel formation unit that forms pixels is provided. In other words, the display unit 11 includes a plurality of pixel formation units. The plurality of pixel formation units are arranged in a matrix in a pixel array. Each pixel formation unit includes a thin film transistor 12 (TFT), which is a switching element having a gate terminal connected to a scan signal line GL passing through the corresponding intersection and a source terminal connected to an image signal line passing through the corresponding intersection, a pixel electrode 13 connected to a drain terminal of the thin film transistor 12, a common electrode 14, which is an opposite electrode for applying a common potential to the plurality of pixel formation units, and a liquid crystal layer sandwiched between the pixel electrode 13 and the common electrode 13 provided in common with the plurality of pixel formation unit. An image capacitance CP is formed by a liquid crystal capacitance formed by the pixel electrode 13 and the common electrode 14. Generally, an auxiliary capacitance is provided in parallel with the liquid crystal capacitance in order to reliably maintain voltage in the pixel capacitance Cp, but the auxiliary capacitance is not directly related to the present invention, and thus, descriptions and depictions thereof are omitted. In the display unit 11 in FIG. 2, only components corresponding to one pixel formation unit are shown.

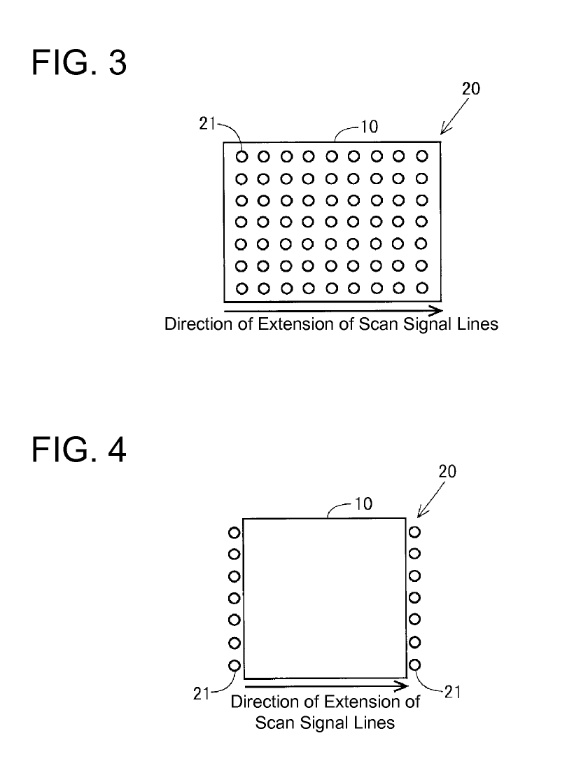

The backlight 20 is provided on the rear surface side of the liquid crystal panel 10 and radiates light to the rear surface of the liquid crystal panel 10. Here, LEDs (light emitting diodes) are assumed to be used as the light sources of the backlight. However, other light emitting members that can be electrically controlled and that are not LEDs (fluorescent lamp, for example) may also be used as the light sources of the backlight. FIG. 3 is a plan view that shows a backlight 20 of the present embodiment. As shown in FIG. 3, the backlight 20 is constituted of a plurality of LEDs 21 disposed in a plane directly below the liquid crystal panel 10. In other words, in the present embodiment, a direct lit type backlight is used. An edge-lit type backlight in which LEDs 21 are provided on both edges of the liquid crystal panel 10 as shown in FIG. 4 can be adopted.

The display control circuit 50 receives image data DAT and various timing signals TS from outside and forms the left eye gradation data and the right eye gradation data while adjusting the timing on the basis of the image data DAT. Then, the display control circuit 50 outputs a digital image signal DS including the left eye gradation data and the right eye gradation data, and a group of timing signals TG including horizontal synchronization signals and vertical synchronization signals.

A panel drive control circuit 30 is a circuit for driving the liquid crystal panel 10. The panel drive control circuit 30 includes a scan signal line driving circuit that drives the scan signal line GL and an image signal line driving circuit that drives the image signal line SL. The panel drive control circuit 30 receives the digital image signal DS and the group of timing signals TG from the display control circuit 50 and outputs a scan signal G to the scan signal line GL and outputs an image signal VS for driving to the image signal line SL. During each frame period, the scanning of the scan signal lines GL is performed one after another from one edge to another edge.

The backlight control circuit 40 is a circuit for driving the backlight 20. The backlight control circuit 40 receives the digital image signal DS and the group of timing signals TG from the display control circuit 50 and then outputs a backlight control signal BS in order to control the intensity of the light emitted from each LEDs 21, which are the light source of the backlight.

The image signal VS is applied to each image signal line SL and the scan signal G is applied to each scan signal line GL, thereby controlling the intensity of the light emitted by each LED 21 based on the backlight control signal BS. As a result, a three dimensional image based on the image data DAT sent from outside is displayed onto the display unit 11. According to the present discussion, an area of the liquid crystal panel 10 in which image writing first takes place during each frame period is referred to as the “upper portion of the panel,” and an area of the liquid crystal panel 10 in which image writing last takes place during each frame period is referred to as the “lower portion of the panel.”

### 1.2 Display Control Circuit

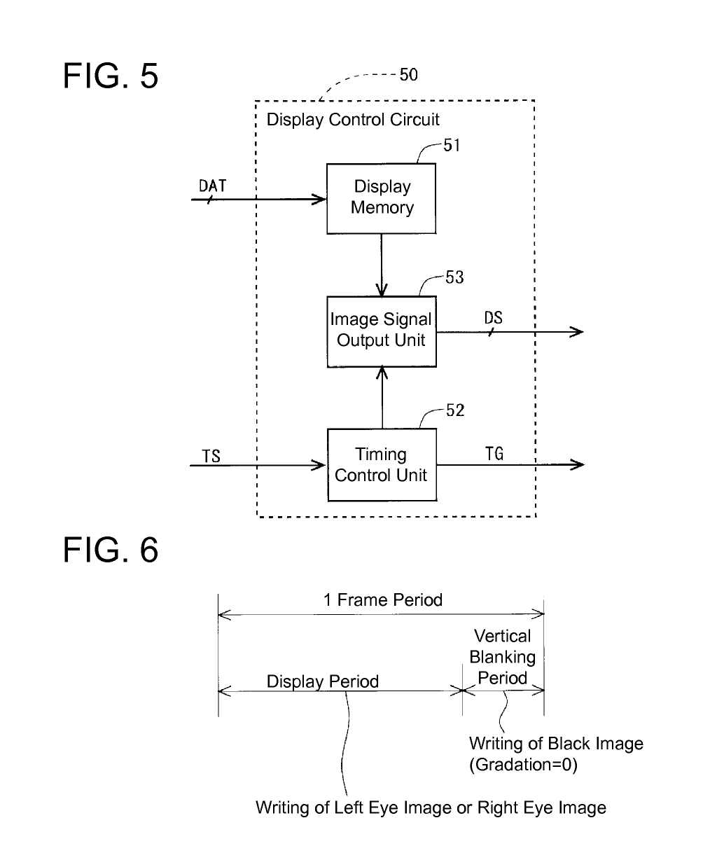

FIG. 5 shows a block diagram of the configuration of a display control circuit 50 of the present embodiment. As shown in FIG. 5, the display control circuit 50 has a display memory 51, a timing control unit 52, and an image signal output unit 53. The display memory 51 stores the image data DAT sent from outside. Based on the timing signal TS sent from outside, the timing control unit 52 controls the operation of the image signal output unit 53 and outputs the group of timing signals TG including signals that control the operation of the scan signal line driving circuit (gate start pulse signal and gate clock signal, for example), signals that control the operation of the image signal line driving circuit (source start pulse signal and source clock signal, for example), signals that control the operation of the backlight control circuit 40, and the like. The image signal output unit 53 outputs, as the digital image signal DS, gradation data based on image data stored in the display memory (left eye gradation data, right eye gradation data) or data indicating a black gradation value in response to controls by the timing control unit 52.

### 1.3 Driving Method

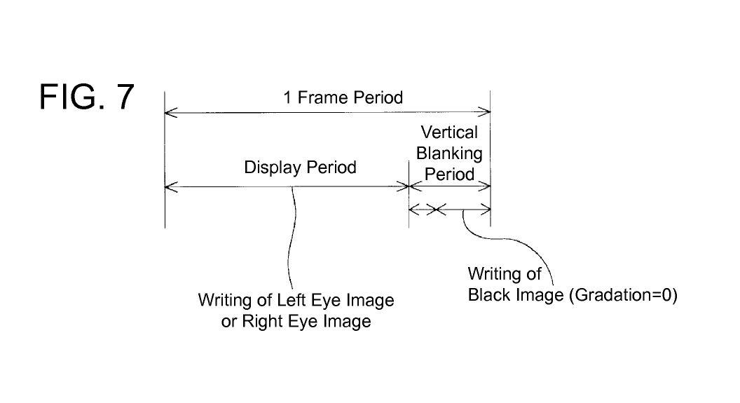

Next, the driving method for realizing three dimensional display for the present embodiment is described. In the present embodiment, a three dimensional display is realized by the frame sequential method. In other words, the left eye image and the right eye image are alternately displayed in the display unit 11, and the lenses of active shutter glasses alternately open and close in synchronization therewith. One frame period includes a display period, which is a period during which a left eye image or a right eye image is written to the liquid crystal panel 10, and a vertical blanking period. As shown in FIG. 6, in the present embodiment, a black image is written to the liquid crystal panel 10 during the vertical blanking period. The black image is an image in which “gradation=0”. Normally, the length of the vertical blanking period is markedly shorter than the display period. Thus, the writing of the black image is performed at a faster speed than the writing of the left eye image and the right eye image. As shown in FIG. 7, the writing of the black image to the liquid crystal panel 10 may be performed during a portion of the vertical blanking period, but in this case, the description assumes that a black image is written to the liquid crystal panel 10 through the entire vertical blanking period.

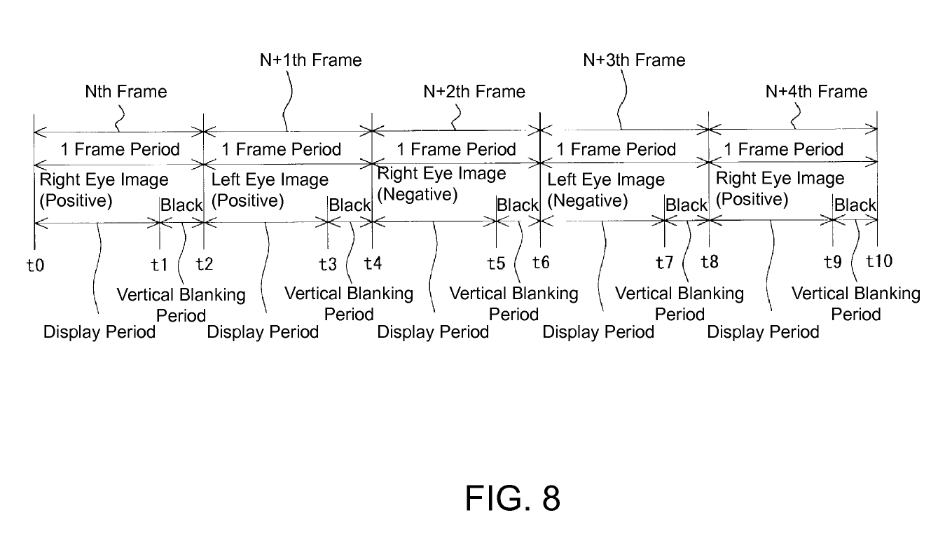

Here, if the Nth frame is presupposed to be the period when the right eye image is being written, then FIG. 8 shows the progression of the image writing from the Nth frame to the N+4th frame. Based on FIG. 8, the following can be understood, for example. The period from the time t2 to the time t4 is the N+1th frame, and during the display period during this frame period (period from the time t2 to the time t3), a positive left eye image is written, and a black image is written during the vertical blanking period (period from the time t3 to the time t4) during this frame period.

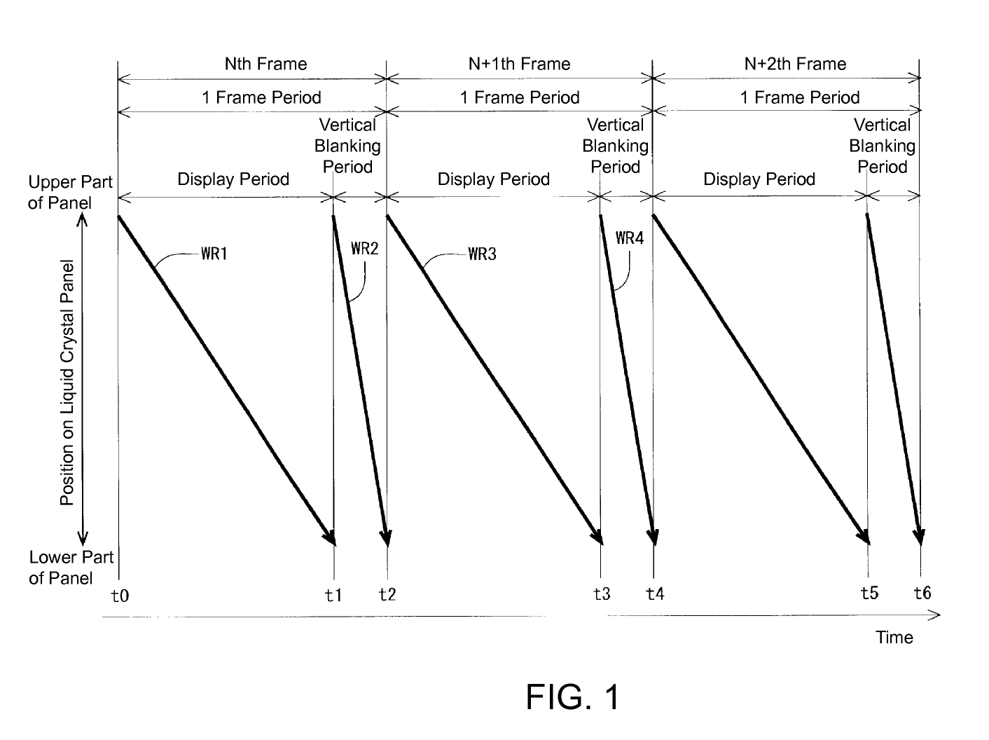

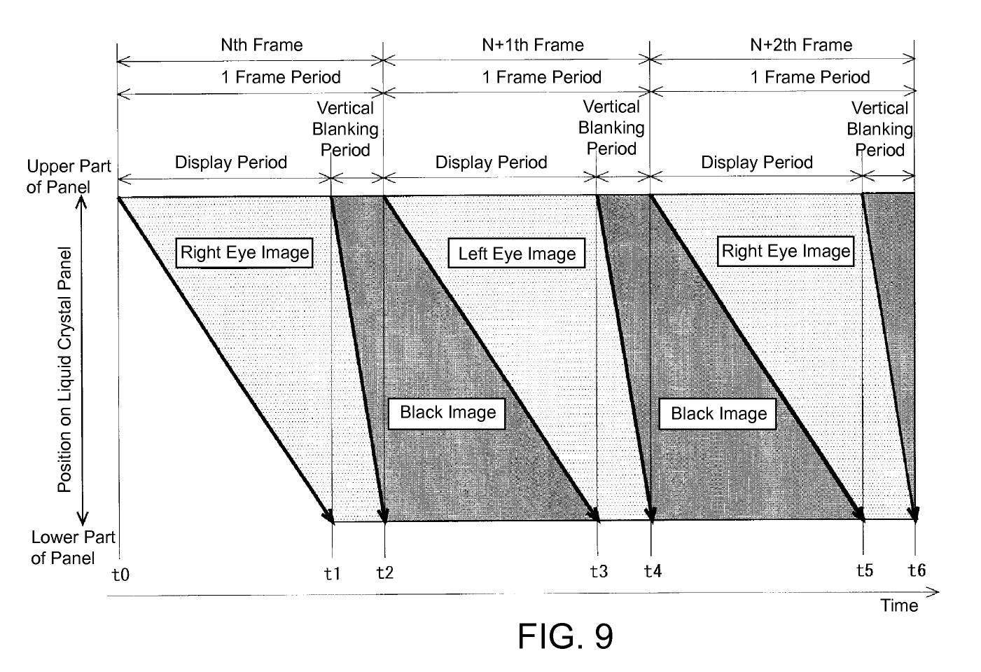

FIGS. 1 and 9, schematically show the progression of pixel writing in the respective regions on the liquid crystal panel 10. During the Nth frame, the right eye image is written in order from the upper portion of the panel to the lower portion of the panel from the time t0 to the time t1 (see arrow with the reference character WR1 in FIG. 1), and a black image is written in order from the upper portion of the panel to the lower portion of the panel from the time t1 to the time t2 (see arrow with the reference character WR2 in FIG. 1). In the N+1th frame, a left eye image is written in order from the upper portion of the panel to the lower portion of the panel from the time t2 to the time t3 (see arrow with reference character WR3 in FIG. 1), and a black image is written in order from the upper portion of the panel to the lower portion of the panel from the time t3 to the time t4 (see arrow with reference character WR4 in FIG. 1). Such operations are repeated from the N+2th frame and thereafter. The holding periods for the right eye image, the left eye image, and the black image in respective positions on the liquid crystal panel 10 can be understood with reference to FIG. 9.

### 1.4 Effects

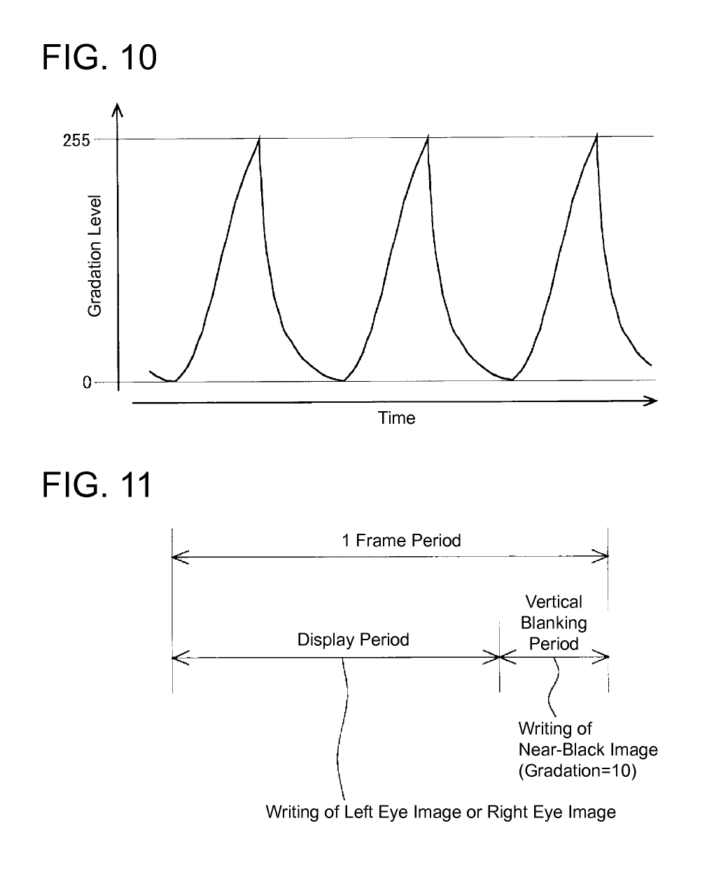

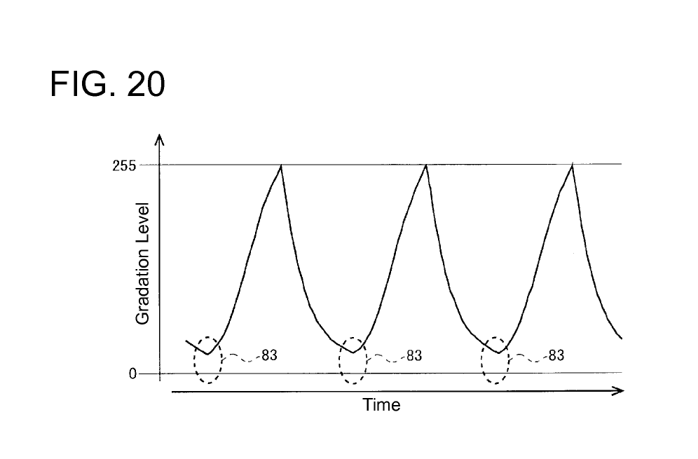

According to the present embodiment, in a liquid crystal display device that realizes three dimensional display by the frame sequential method, writing of the black image is performed during the vertical blanking period of each frame period. As a result, when the difference in gradation value between the left eye image and the right eye image is large, writing of the lower gradation image to the liquid crystal panel 10 is performed twice during one frame period. Therefore, when a low gradation image is written, the gradation level that is reached can be sufficiently reduced. As a result, if the gradation value of the right eye image is 255 and the gradation value of the left eye image is 0 in a certain pixel, for example, then the change in luminance (gradation level) in that pixel is as shown in FIG. 10 in the present embodiment, whereas in conventional configurations, it would have been similar to what is shown in FIG. 20. In other words, in the present embodiment, if writing of a low gradation image is performed after the high gradation image is written, then the gradation level reaches 0 by the time writing of the next high gradation image occurs. Thus, unlike in conventional configurations, an image having excess gradation is not perceived. As mentioned above, the present embodiment realizes a liquid crystal display device that can perform three dimensional display and that can suppress low image quality caused by crosstalk when the difference in gradation level between the left eye image and the right eye image is large.

### 1.5 Modification Examples

In Embodiment 1, the writing of a black image that corresponds to “gradation value=0” is performed during the vertical blanking period, but the present invention is not limited to this. As shown in FIG. 11, the writing of a near-black image in which “gradation value=10” (image having a gradation value of less than or equal to one tenth of the maximum gradation value), for example, may be performed during the vertical blanking period. As a result, it is possible to suppress the decrease in luminance in high gradation images.

### 2. Embodiment 2

### 2.1 Configuration and the Like

Next, Embodiment 2 of the present invention will be described. The overall configuration and configuration of the display control circuit 50 are similar to those of Embodiment 1 (see FIGS. 2 to 5), and thus, descriptions thereof are omitted. However, in the present embodiment, the interlace driving method is adopted. Therefore, if one frame period is 1/120 of a second, then a digital image signal DS for even lines during a frame period is outputted from the display control circuit 50, and during the next frame period, a digital image signal DS for odd lines is outputted from the display control circuit 50. Then, the right eye image is written when the even numbered scan signal lines GL among the plurality of scan signal lines GL disposed in the display unit 11 are scanned, and the left eye image is written when the odd numbered scan signal lines GL among the plurality of scan signal lines GL are scanned. By writing the right eye image in the even lines and the left eye image in the odd lines over two frame periods, one full image is displayed in the display unit 11. In the present description, it is assumed that the right eye image is displayed in the even lines, and that the left eye image is displayed in the odd lines, but the left eye image may be displayed in the even lines and the right eye image may be displayed in the odd lines.

### 2.2 Driving Method

Next, the driving method for realizing three dimensional display in the present embodiment is described. Similar to Embodiment 1, even for the present embodiment, one frame period includes a display period including a period during which a left eye image or a right eye image is written to the liquid crystal panel 10, and a vertical blanking period. As shown in FIG. 7, in the description of the present embodiment, it is assumed that the black image is written to the liquid crystal panel 10 during a portion of the vertical blanking period. However, the black image may be written to the liquid crystal panel 10 through the entire vertical blanking period a manner similar to Embodiment 1 (see FIG. 6).

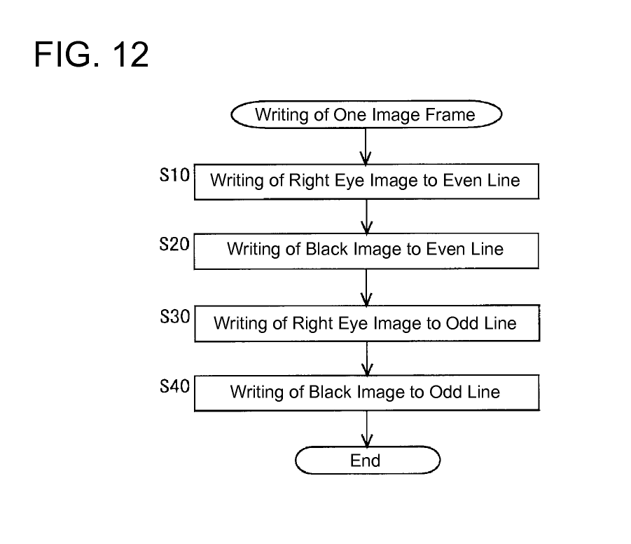

FIG. 12 is a flow chart showing the process of image writing for one screen according to the present embodiment. First, the writing of the right eye image is performed in the even lines among the plurality of lines that constitute a pixel matrix (step S10). After the right eye image is written to the even lines, a black image is written to the even lines. Next, the left eye image is written to the odd lines of the plurality of lines that constitute the pixel matrix (step S30). After the left eye image is written to the odd lines, a black image is written to the odd lines. In the manner above, the writing of an image for one frame is performed.

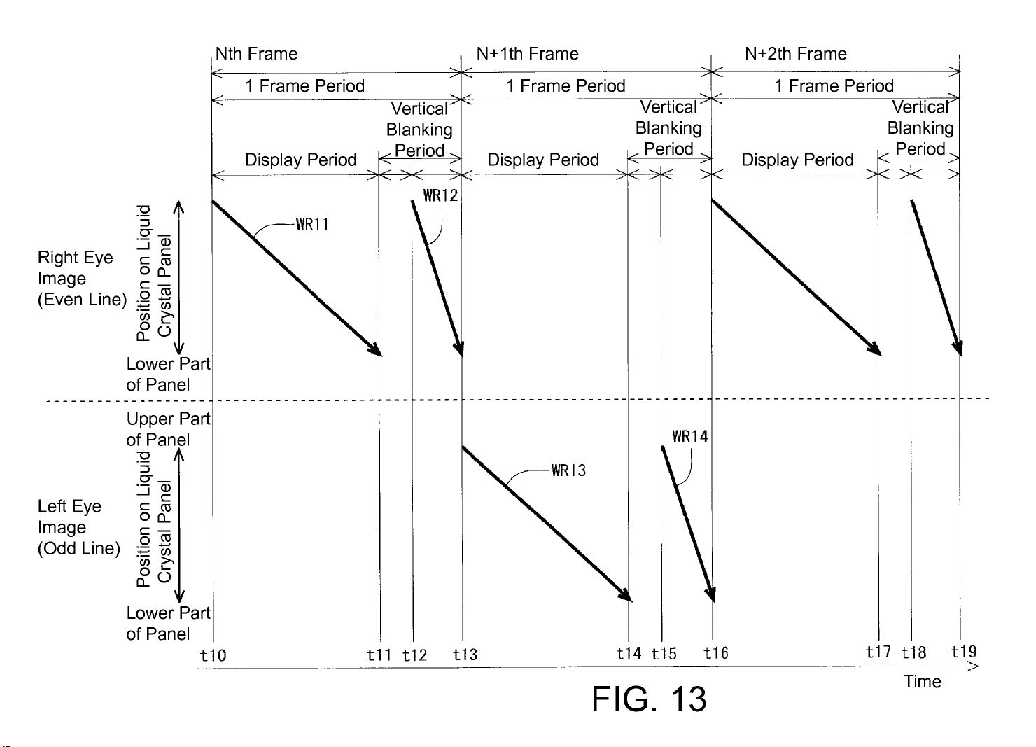

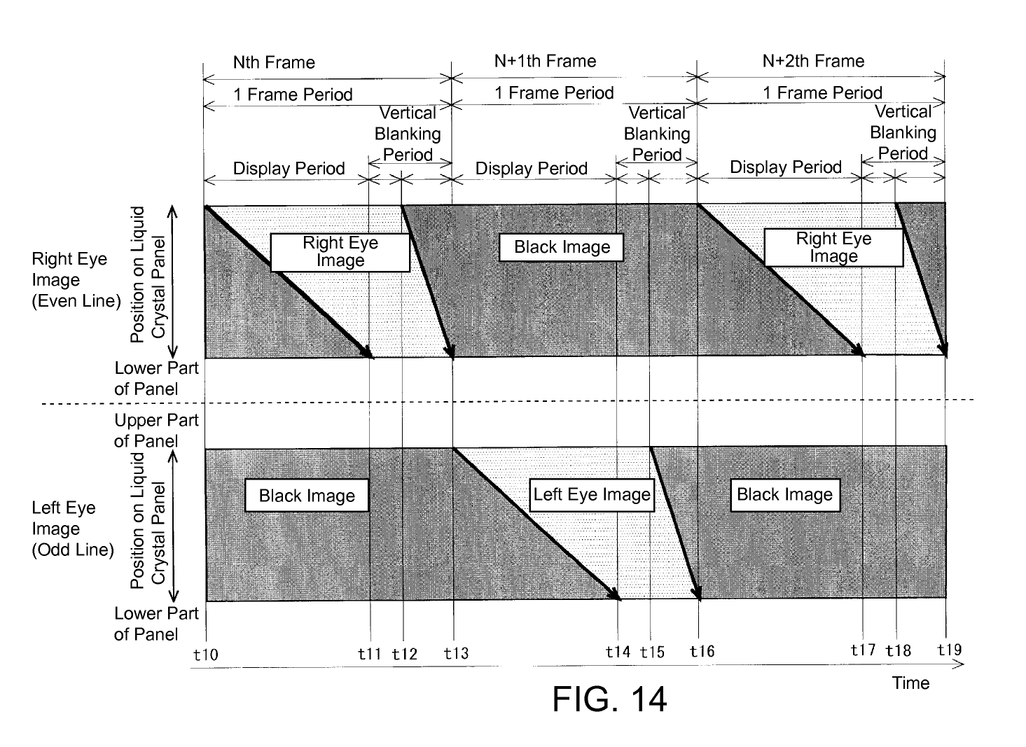

FIGS. 13 and 14, schematically show the progression of pixel writing in the respective regions on the liquid crystal panel 10. In FIGS. 13 and 14, it is assumed that the Nth frame is a period for writing the right eye image. During the Nth frame, writing of the right eye image is performed in order from the upper portion of the panel to the lower portion of the panel from the time t10 to the time t11 (see arrow with the reference character WR1 in FIG. 13), and a black image is written in order from the upper portion of the panel to the lower portion of the panel from the time t12 to the time t13 (see arrow with the reference character WR12 in FIG. 13). In the N+1th frame, the left eye image is written from the upper portion of the panel to the lower portion of the panel of the odd line in that order from time t13 to time t14 (see arrow with the reference character WR13 in FIG. 13), and a black image is written from the upper portion of the panel to the lower portion of the panel in that order from time t15 to time t16 (see the arrow shown in FIG. 13 with the reference character WR14). Such operations are repeated from the N+2th frame and thereafter. The period during which the right eye image and the black image are held in the liquid crystal panel 10 at the respective positions of the even lines and the period during which the left eye image and the black image are held in the liquid crystal panel 10 at the respective positions of the odd lines can be understood from FIG. 14.

### 2.3 Concerning Overshoot Driving

As will be mentioned later, according to the present embodiment, the overshoot driving method (method of driving liquid crystals by making adjustments that emphasize change over time of the input image signal) does not need to be adopted. Thus, overshoot driving is described.

Because the response speed is low for liquid crystals, when a video is displayed in a liquid crystal display device, there are cases in which a sufficient image quality cannot be obtained. In particular, the response speed during the gradation change from the mid-level gradation is markedly low. Thus, in order to suppress a drop in response speed of the liquid crystals during video display, a driving method called overshoot driving is conventionally used. In overshoot driving, an input image signal of an immediately preceding frame and an input image signal of the current frame are combined, and a driving voltage that is higher or lower than a gradation voltage corresponding to the current frame input image signal is supplied to the display unit based on this combination. By adopting this type of overshoot driving, the time needed to reach the gradation voltage corresponding to the input image signal of the current frame is shortened, and the decrease in image quality during video display is suppressed.

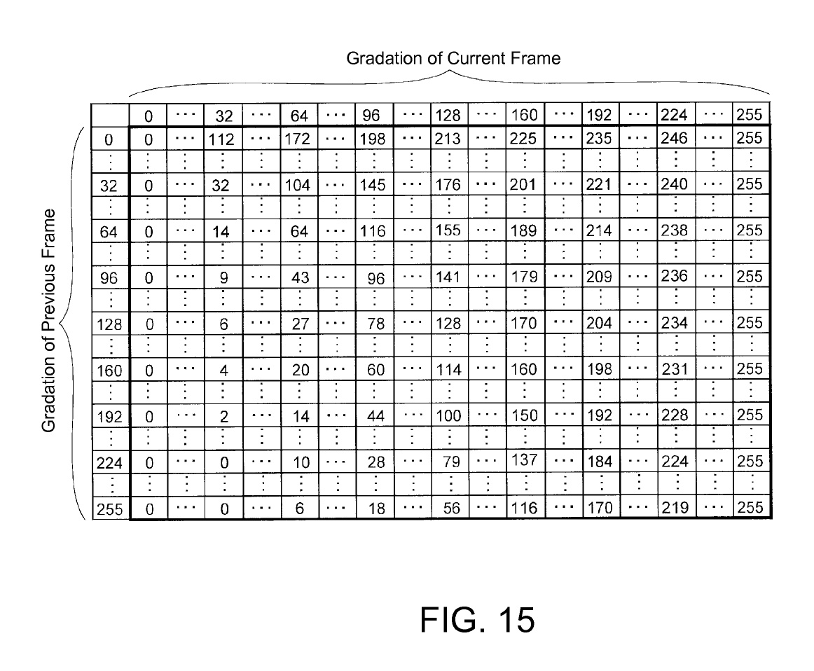

In liquid crystal display devices that use overshoot driving, lookup tables (overshoot LUTs) are stored so that the driving voltage is determined on the basis of a combination of gradation values corresponding to the inputted image signals of the immediately preceding frame (hereinafter, “immediately preceding frame gradation values”) and gradation values corresponding to the inputted image signals of the current frame (hereinafter, “current frame gradation values”). FIG. 15 is a schematic view showing an example of the overshoot LUT stored in a liquid crystal display device that can perform 256-gradation display. In FIG. 15, the values in the leftmost column show the immediately preceding frame gradation values, and the values in the uppermost row show the current frame gradation values. The value where each row and each column intersect each other is a gradation value (hereinafter, “applied gradation value”) corresponding to the driving voltage determined on the basis of the combination of the respective immediately preceding frame gradation values and the respective current frame gradation values. If the immediately preceding frame gradation value is 64 and the current frame gradation value is 128, for example, then the applied gradation value is 155. If the immediately preceding frame gradation value is 160 and the current frame gradation value is 64, for example, then the applied gradation value is 20. Thus, a driving voltage that is higher or lower than the gradation voltage corresponding to the input image signal of the current frame is applied to the liquid crystals on the basis of the data stored in the overshoot LUTs.

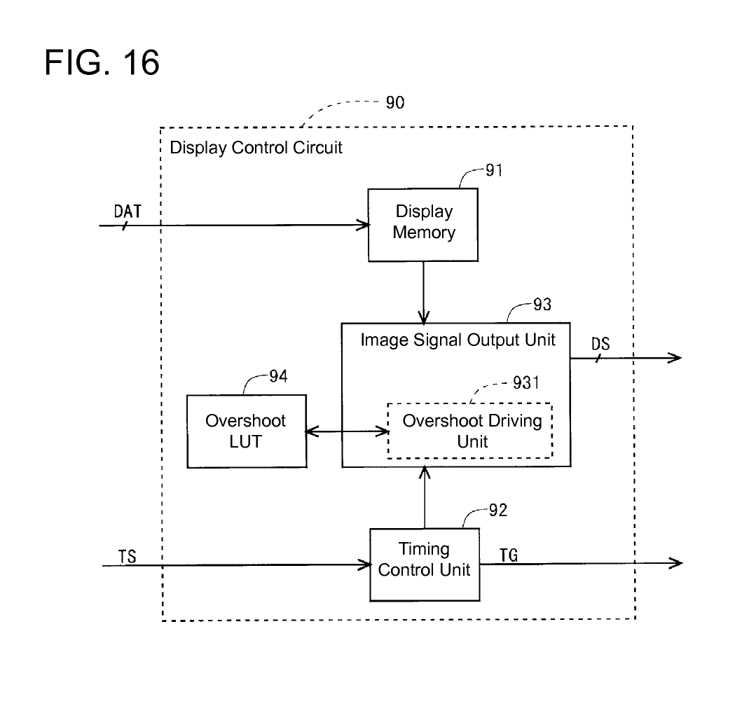

The configuration of a liquid crystal display control circuit for a liquid crystal display device that uses overshoot driving is as shown in FIG. 16, for example. In addition to the constituting elements shown in FIG. 5, the display control circuit 90 includes the overshoot LUT 94. Furthermore, an overshoot driving unit 931 is included in the image signal output unit 93. The overshoot driving unit 931 performs corrections based on the overshoot LUT 94 to the gradation value based on the image data stored in the display memory 91, thereby finding the gradation value of the data to be outputted as the digital image signal DS.

As mentioned above, the configuration of a liquid crystal display control circuit for a liquid crystal display device that uses overshoot driving is as shown in FIG. 16, for example. By contrast, in the liquid crystal display device of the present embodiment, the display control circuit is configured as shown in FIG. 5. Taking this into consideration, the effect of the present embodiment is explained below.

### 2.4 Effects

As can be understood from FIG. 14, in the present embodiment, a black image is stored in the odd lines during the period when the right eye image is written, and a black image is stored in the even lines during the period when the left eye image is written. Therefore, at the respective positions on the liquid crystal panel 10, the period during which the black image is held becomes longer than in Embodiment 1. Thus, it is possible for the gradation level to more reliably reach 0 during the period when the black image is held. As a result, when the difference in gradation level is high between the left eye image and the right eye image, the decrease in image quality caused by crosstalk can be effectively suppressed.

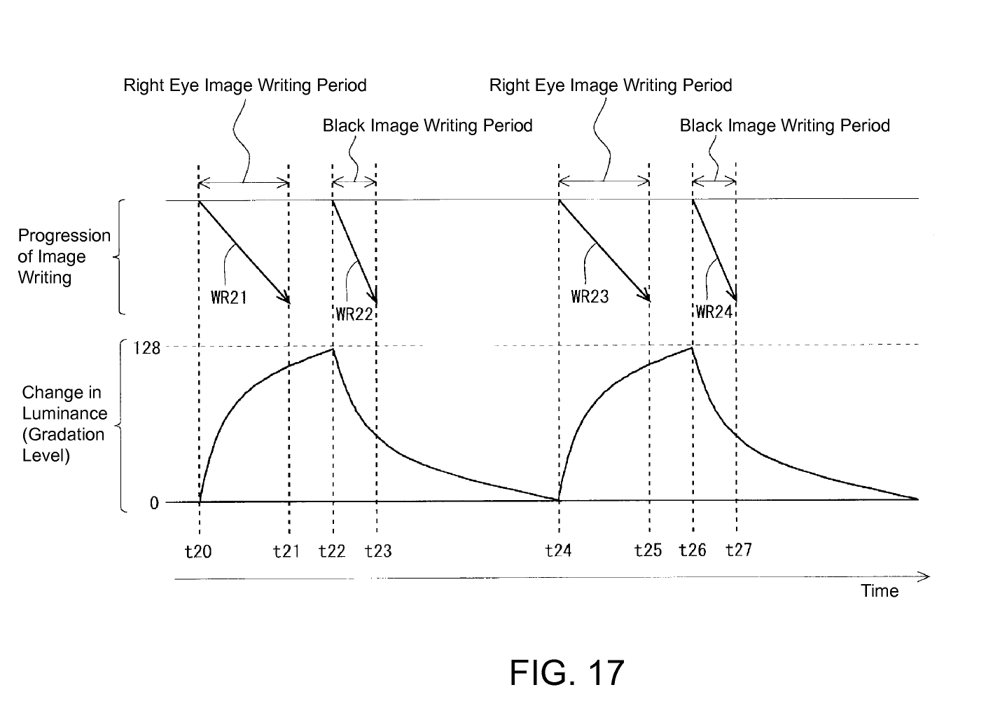

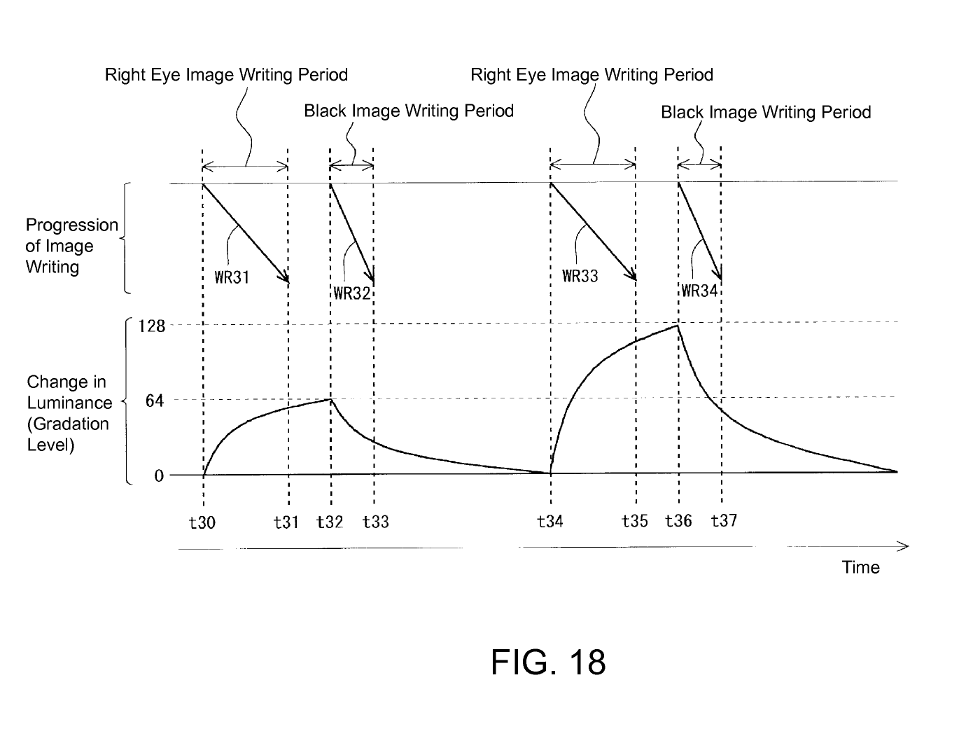

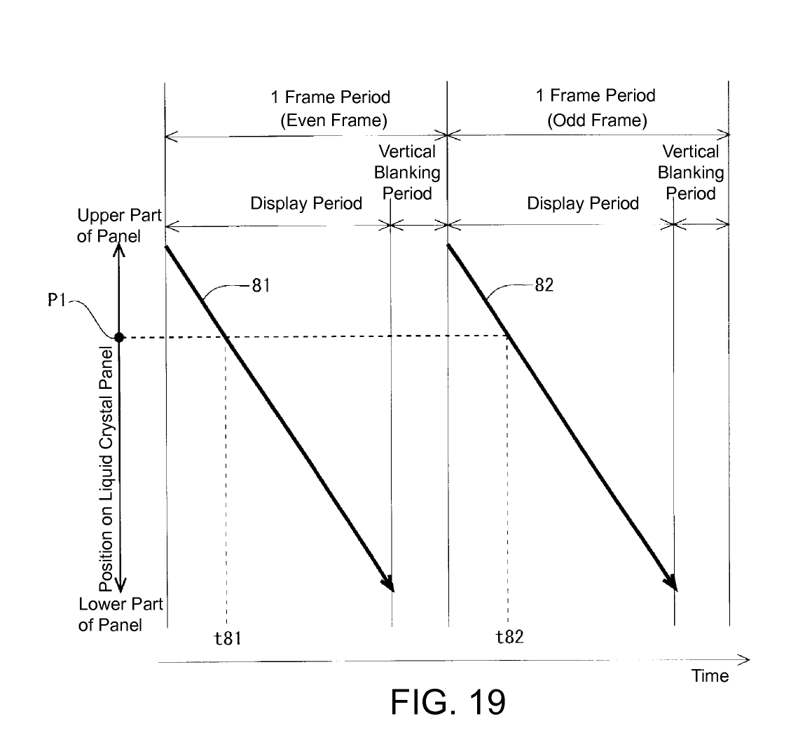

In addition, overshoot driving is unnecessary for the present embodiment as explained below. When the gradation value progresses from 128 to 128 in a certain pixel, the progression of image writing and change in luminance (gradation level) is as shown in FIG. 17. Once writing of the right eye image at time t20 starts, the gradation level changes from 0 to 128 during the period between the time t20 and t22. Then, once writing of the black image starts at time t22, the gradation level changes from 128 to 0 from the time t22 to the time t24. In this manner, at the point when writing the image with the gradation value of 128 begins for a second time, the gradation value is at 0. Also, when the gradation value progresses from 64 to 128 in a certain pixel, the progression of image writing and change in luminance (gradation level) is as shown in FIG. 18. Once writing of the right eye image to time t30 starts, then the gradation level changes from 0 to 64 during the period from the time t30 to the time t32. Then, once writing of the black image starts at time t32, the gradation level changes from 64 to 0 from the time t32 to the time t34. In this manner, at the point when writing of the image with the gradation value of 128 starts, the gradation value is at 0. As mentioned above, regardless of the state of progression of the gradation value, when writing of the right eye image and the left eye image starts for each pixel, the gradation level is at 0. In other words, a gradation change from the intermediate gradation will not occur when writing of the right eye image or the left eye image is performed. Therefore, when writing of the right eye image or the left eye image is performed, the liquid crystals respond promptly. Therefore, overshoot driving is unnecessary for the present embodiment. As a result, the circuit size of the display control circuit and the memory capacitance can be made smaller.

### DESCRIPTION OF REFERENCE CHARACTERS

10 liquid crystal panel

11 display unit

20 backlight

21 LED

30 panel drive control circuit

40 backlight control circuit

50 display control circuit

What is claimed is:

1. A liquid crystal display device, comprising:
a liquid crystal panel including a plurality of scan signal lines and a plurality of image signal lines that intersect with the plurality of scan signal lines, the liquid crystal panel displaying a three dimensional image by alternately displaying a left eye image and a right eye image;
a plurality of light sources as a backlight that radiates light to a rear surface of the liquid crystal panel;
a light source control unit that controls an intensity of light emitted by the plurality of light sources; and
a liquid crystal panel driving unit that drives the liquid crystal panel,
wherein the liquid crystal panel driving unit writes to the liquid crystal panel the left eye image and the right eye image in alternating frame periods from one edge to an opposite edge of the liquid crystal panel in a direction extending along the plurality of image signal lines, and writes to the liquid crystal panel a near-black image or a black image from said one edge to said opposite edge of the liquid crystal panel during a vertical blanking period in each frame period.

2. The liquid crystal display device according to claim 1, wherein the liquid crystal panel driving unit scans the plurality of scan signal lines in an interlacing fashion such that either one of the left eye image and the right eye image is displayed by scanning odd numbered scan signal lines among the plurality of scan signal lines, and another of the left eye image and the right eye image is displayed by scanning even numbered scan signal lines among the plurality of scan signal lines.

3. The liquid crystal display device according to claim 1, wherein the liquid crystal panel driving unit writes to the liquid crystal panel the near-black image or the black image at a speed faster than a speed by which the left eye image or the right eye image is written to the liquid crystal panel.

4. The liquid crystal display device according to claim 1, wherein the liquid crystal panel driving unit writes the black image to the liquid crystal panel during the vertical blanking period in each frame period.

5. The liquid crystal display device according to claim 1, wherein the liquid crystal panel driving unit writes the near-black image to the liquid crystal panel during the vertical blanking period in each frame period.

6. The liquid crystal display device according to claim 5, wherein the near-black image is an image having a gradation of one tenth of a maximum gradation value.

7. A method of driving a liquid crystal display device including: a liquid crystal panel including a plurality of scan signal lines and a plurality of image signal lines that intersect with the plurality of scan signal lines; and a plurality of light sources as a backlight that radiates light to a rear surface of the liquid crystal panel, the liquid crystal panel displaying a three dimensional image by alternately displaying a left eye image and a right eye image, the method comprising:
controlling an intensity of light emitted by the plurality of light sources; and
driving the liquid crystal panel,
wherein, in the step of driving the liquid crystal panel, the left eye image and the right eye image are written to the liquid crystal panel in alternating frame periods from one edge to an opposite edge of the liquid crystal panel in a direction extending along the plurality of image signal lines, and a near-black image or a black image is written to the liquid crystal panel during a vertical blanking period of each frame period from said one edge to said opposite edge of the liquid crystal panel.
